(19) United States
(12) Patent Application Publication
(10) Pub. No.: US 2019/0302957 A1
(43) Pub. Date: Oct. 3, 2019

(54) DISPLAY/INPUT DEVICE AND IMAGE FORMING APPARATUS INCLUDING SAME

(71) Applicant: KYOCERA Document Solutions Inc., Osaka (JP)

(72) Inventor: Jiro NAGIRA, Osaka (JP)

(73) Assignee: KYOCERA Document Solutions Inc., Osaka (JP)

(21) Appl. No.: 16/363,553

(22) Filed: Mar. 25, 2019

(30) Foreign Application Priority Data
Mar. 29, 2018 (JP) 2018-065129

(51) Int. Cl. G06F 3/041; G06F 1/3234

(52) U.S. Cl. CPC G06F 3/0416; G06F 1/3262; G06F 3/0412

(57) ABSTRACT

A display/input device includes a touch screen and a controller which detects a contact point of a contacted body with respect to the touch screen, and which, when the number of the contact point detected simultaneously is equal to or more than a threshold value set at a value that is equal to or more than two, shifts to a panel cleaning mode in which an operation with respect to the touch screen is made ineffective.

### INCORPORATION BY REFERENCE

This application is based upon and claims the benefit of priority from the corresponding Japanese Patent Application No. 2018-065129 filed on Mar. 29, 2018, the entire contents of which are incorporated herein by reference.

### BACKGROUND

The present disclosure relates to a display/ input device and an image forming apparatus including the same.

Image forming apparatuses are often provided with a display/input device having a touch screen. A user operates such a display/input device having a touch screen by touching the touch screen. Thus, the touch screen is liable to become dirty. When the user finds the touch screen dirty, he or she cleans the touch screen. The user usually uses a cloth to wipe the dirt off the touch screen.

Here, there may be a case where the user performs a wiping operation with a software button displayed on the touch screen. In such a case, the wiping operation performed by the user with respect to the display region of the software button can be detected as an operation performed with respect to the software button. If the wiping operation is detected as an operation performed with respect to the software button, processing corresponding to the software button will be performed against the user's intention, and this is inconvenient. Occurrence of such an inconvenient situation can be reduced by performing the wiping operation with the display/input device turned off. However, needing to switch the on/off of the display/input device bothers the user, and thus makes the display/input device inconvenient to the user.

### SUMMARY

According to a first aspect of the present disclosure, a display/input device includes a touch screen and a controller. The controller detects a contact point of a contacted body with respect to the touch screen, and, when a number of the contact point detected simultaneously is equal to or more than a threshold value set to a value equal to or more than two, the controller shifts to a panel cleaning mode in which an operation with respect to the touch screen is made ineffective.

According to a second aspect of the present disclosure, an image forming apparatus includes the display/input device described above.

### BRIEF DESCRIPTION OF THE DRAWINGS

FIG. 1 is a block diagram illustrating a configuration of an operation panel according to an embodiment of the present disclosure and a configuration of an image forming apparatus including the operation panel.

FIG. 2 is plan view illustrating the configuration of the operation panel according to the embodiment of the present disclosure.

FIG. 3 is a diagram illustrating a state in which a cloth for cleaning is pressed against a touch screen of the operation panel according to the embodiment of the present disclosure.

FIG. 4 is a flowchart illustrating a flow of starting-condition judging processing and ending-condition judging processing performed by a panel controller of the operation panel according to the embodiment of the present disclosure.

FIG. 5 is a diagram illustrating a first range and a second range in the touch screen of the operation panel according to the embodiment of the present disclosure.

FIG. 6 is a diagram for illustrating a wiping operation performed with respect to the touch screen of the operation panel according to the embodiment of the present disclosure.

FIG. 7 is a diagram illustrating a software button which the panel controller of the operation panel according to the embodiment of the present disclosure can recognize as a target button.

### DETAILED DESCRIPTION

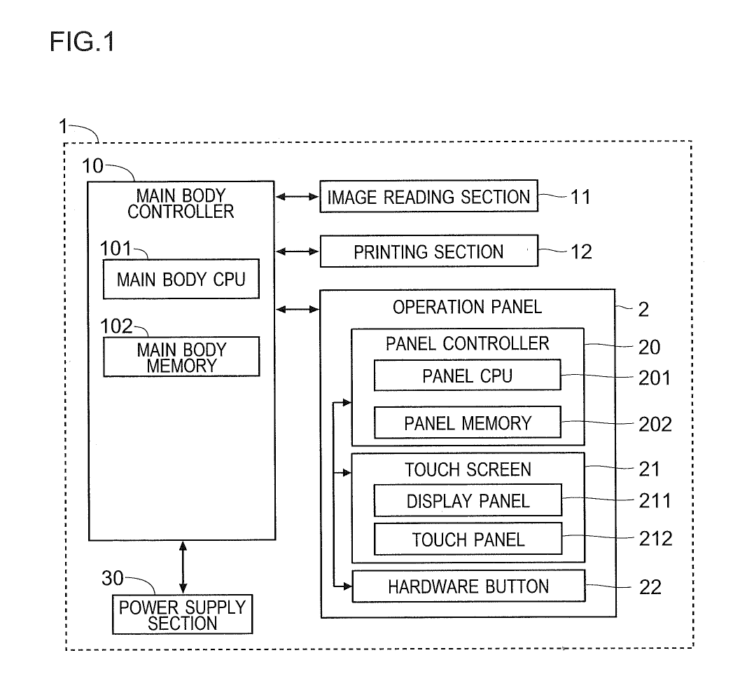

Device Configuration: As illustrated in FIG. 1, an image forming apparatus 1 of this embodiment includes an image reading section 11 and a printing section 12. The image reading section 11 reads a document to produce image data of the document. The printing section 12 prints, on a sheet, an image based on image data (for example, the image data of the document obtained by the reading performed by the image reading section 11).

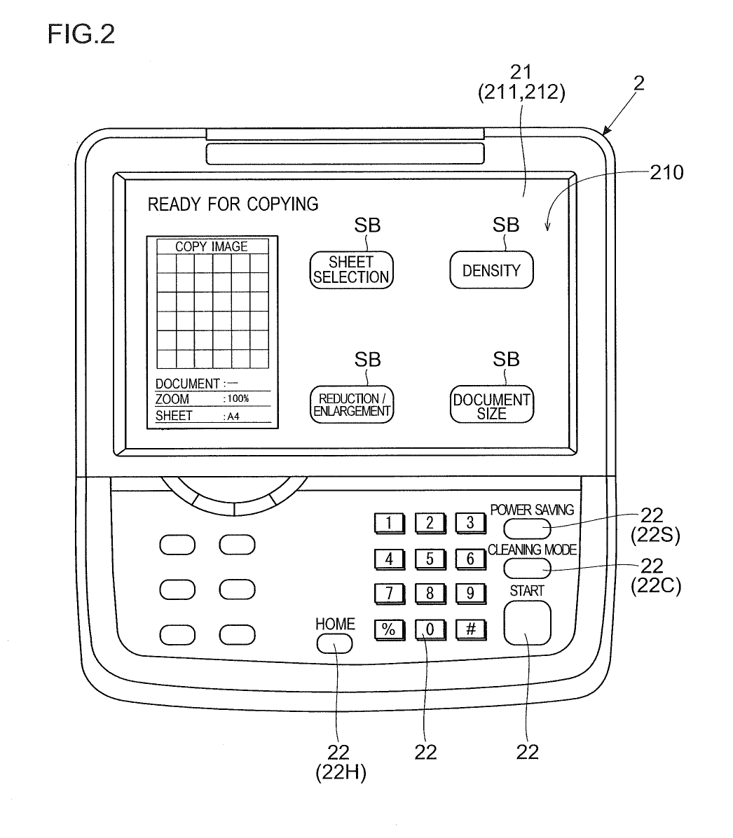

Here, the image forming apparatus 1 includes an operation panel 2 as illustrated in FIG. 2. The operation panel 2 corresponds to “a display/input device”.

The operation panel 2 includes a touch screen 21. The touch screen 21 includes a display panel 211 and a touch panel 212. The display panel 211 is a liquid crystal display panel provided with a backlight. The touch panel 212 is a multi-touch panel capable of simultaneously detecting a plurality of contact points. The touch panel 212 is disposed on a surface of the display panel 211.

The surface of the touch screen 21 (the surface of the touch panel 212) is quadrangular in shape, and serves as an operation accepting surface 210. The touch screen 21 displays, on the display panel 211, a screen on which software buttons SB are arranged for accepting various settings. The touch screen 21 also accepts, from a user, via the touch panel 212, an operation performed with respect to any one of the software buttons SB arranged on the displayed screen (the operation will be referred to as a button operation).

The operation panel 2 is provided with various hardware buttons 22 including a start button for accepting an instruction to execute a job and a ten-key pad for accepting inputs of numbers. The operation panel 2 is also provided with, as the hardware buttons 22, a home button 22H, a power-saving button 22S, and the like. When the user has performed a pressing operation with respect to the home button 22H, the screen displayed on the operation panel 2 returns to a home screen (an initial screen). When the user has performed a pressing operation with respect to the power-saving button 22S, the display on the operation panel 2 is stopped (in other words, the image forming apparatus 1 shifts from a normal mode to a power-saving mode).

Back to FIG. 1, the image forming apparatus 1 includes a main body controller 10. The main body controller 10 includes a main body CPU 101 and a main body memory 102 (a ROM and a RAM). The main body controller 10 is connected to the image reading section 11 and to the printing section 12, and controls a reading operation performed by the image reading section 11 and a printing operation performed by the printing section 12, based on a control program and control data.

The operation panel 2 also includes a panel controller 20. The panel controller 20 corresponds to “a controller”. The panel controller 20 includes a panel CPU 201 and a panel memory 202 (a ROM and a RAM).

The panel controller 20 is connected to the main body controller 10. The panel controller 20 performs panel control processing for controlling the operation panel 2 in response to an instruction received from the main body controller 10. The panel controller 20 performs, as the panel control processing, processing of controlling a display operation performed by the touch screen 21. A display program for making the touch screen 21 display a screen, screen data regarding the screen, etc. are stored in the panel memory 202.

The panel controller 20 also performs, as the panel control processing, processing of detecting, based on an output of the touch screen 21, whether or not a contacted body has been brought into contact with the operation accepting surface 210 of the touch screen 21. In a case where a contact of a contacted body with respect to the operation accepting surface 210 has been detected, the panel controller 20 performs, for example, processing of detecting the position (coordinates) of a contact point of the contacted body with respect to the operation accepting surface 210, processing of detecting the number of contact points of the contacted body with respect to the operation accepting surface 210, etc. Here, the panel controller 20 also performs detection of pressing operations performed with respect to the hardware buttons 22.

For example, the panel controller 20 judges whether or not the user has performed a button operation (that is, whether or not a contact point of the contacted body with respect to the touch screen 21 overlaps with a software button SB). In a case where the panel controller 20 has judged that the user has performed a button operation (that is, whether or not the contact point of the contacted body with respect to the touch screen 21 overlaps with a software buttons SB), the panel controller 20 performs processing (for example, processing of changing the screen displayed on the touch screen 21) corresponding to the software button SB that has been the target of the button operation. Normally, the user performs a button operation with one of his or her fingers (that is, the user touches the display region of a software button SB with one of his or her fingers). Thus, in a case where the user performs a button operation, just one contact point is detected by the panel controller 20.

The image forming apparatus 1 also includes a power supply section 30. The power supply section 30 is connected to a commercial power supply (an alternate-current power supply). The power supply section 30 includes a power supply circuit which generates voltage and a control circuit which controls supply of power. The power supply section 30 supplies power to all the components of the image forming apparatus 1, such as the main body controller 10, the image reading section 11, the printing section 12, the operation panel 2, and so forth, to make these components operate. In other words, the main body controller 10, the image reading section 11, the printing section 12, and the operation panel 2 are power-receiving components which operate with power supplied from the power supply section 30.

Power Supply Modes: As power supply modes of the power supply section 30, there are prepared a normal mode and a power-saving mode (which is sometimes referred to as a sleep mode). In the normal mode, the power supply section 30 performs a normal power supply with respect to the power-receiving components. In the power-saving mode, the power supply section 30 supplies less power to the power-receiving components than in the normal mode.

When performing power supply in the normal mode, the main body controller 10 performs shift judging processing of judging whether or not a shifting condition, which has been determined in advance as a condition for shifting from the normal mode to the power-saving mode, has been fulfilled. In a case where the main body controller 10 has judged that the shifting condition has been fulfilled, the main body controller 10 instructs the power supply section 30 to shift the power supply mode from the normal mode to the power-saving mode.

For example, when the power supply mode is the normal mode, the main body controller 10 performs, as the shift judging processing, processing of judging whether or not the power-saving button 22S (see FIG. 2) on the operation panel 2 has been operated. If the power-saving button 22S has been operated, the main body controller 10 judges that the shifting condition has been fulfilled.

Or, when the power supply mode is the normal mode, the main body controller 10 counts a non-use time, which is a time that passes without the image forming apparatus 1 being used, and the main body controller 10 performs, as the shift judging processing, processing of judging whether or not the non-use time has exceeded an upper limit time which has been determined in advance. If the non-use time has exceeded the upper limit time, the main body controller 10 judges that the shifting condition has been fulfilled.

When the power supply mode is the power-saving mode, the power supply section 30 stops the supply of power to the image reading section 11 and to the printing section 12, but does not completely stop the supply of power to the operation panel 2. More specifically, the power supply section 30 does not stop the supply of power to the touch panel 212, but stops the supply of power to the display panel 211 (the backlight). Consequently, in the power-saving mode, the touch screen 21 displays no screen.

Here, even when the power supply mode is the power-saving mode, the panel controller 20 performs detection of whether or not a contacted body has been brought into contact with the touch screen 21, and in a case where the panel controller 20 has detected contact of a contacted body with respect to the touch screen 21, the panel controller 20 performs detection of contact positions of the contacted body with respect to the touch screen 21 and the number of the contact positions. This is why the power supply section 30 does not completely stop the supply of power to the panel controller 20 when the power supply mode is the power-saving mode.

When the power supply mode is the power-saving mode, the panel controller 20 performs return judging processing of judging whether or not a returning condition, which has been determined in advance as a condition for returning from the power-saving mode to the normal mode, has been fulfilled. In a case where the panel controller 20 has judged that the return condition has been fulfilled, the panel controller 20 transmits a return signal, which indicates that the returning condition has been fulfilled, to the main body controller 10.

When the power supply mode is the power-saving mode, in a case where the panel controller 20 has detected that an operation of touching one point on the touch screen 21 (in this operation, one contact point is detected by the panel controller 20) has been performed, the panel controller 20 judges that the returning condition has been fulfilled. When the power supply mode is the power-saving mode, also in a case where the panel controller 20 has detected that an operation of simultaneously touching two points on the touch screen 21 (in this operation, two contact points are simultaneously detected by the panel controller 20) has been performed, the panel controller 20 judges that the returning condition has been fulfilled. When the power supply mode is the power-saving mode, even if the user performs an operation of simultaneously touching three or more points on the touch screen 21 (that is, even if three or more contact points are simultaneously detected by the panel controller 20), the panel controller 20 does not judge that the returning condition has been fulfilled.

It should be noted that, when the power supply mode is the power-saving mode, the power supply section 30 supplies the main body controller 10 with less power than in the normal mode (in other words, the supply of power to the main body controller 10 is not completely stopped). When the power supply mode is the power-saving mode, the main body controller 10 is in a power-saving state; in the power-saving state, the main body controller 10 does not perform processing such as calculation processing, but accepts only a signal inputted to a part (an interrupt port) of terminals of the main body CPU 101. The return signal from the panel controller 20 is inputted to the interrupt port of the main body CPU 101.

When the return signal is inputted to the interrupt port of the main body CPU 101, the main body controller 10 returns from the power-saving state to a normal state (in which the main body controller 10 is able to perform the calculation processing). Then, the main body controller 10 instructs the power supply section 30 to make the power supply mode return from the power-saving mode to the normal mode. Thereby, the image forming apparatus 1 returns to a ready state (in which the image forming apparatus 1 is able to execute a job). When the power supply mode returns from the power-saving mode to the normal mode, the supply of power to the display panel 211 (the backlight) is restarted, and thus a screen is displayed on the touch screen 21.

Panel Cleaning Mode: When the user performs a button operation with respect to the touch screen 21, he or she touches the operation accepting surface 210 of the touch screen 21 with one of his or her fingers, consequently leaving his or her fingerprint on the operation accepting surface 210. Further, since the operation accepting surface 210 is exposed outside, the operation accepting surface 210 is liable to collect dust and the like. This is why cleaning of the operation accepting surface 210 is performed.

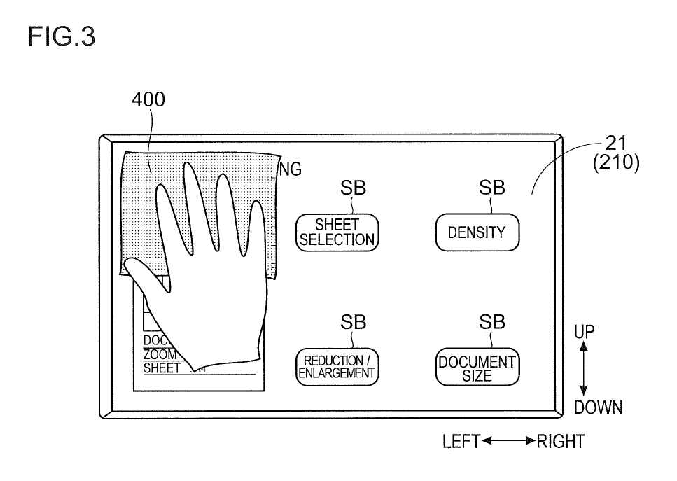

For example, as illustrated in FIG. 3, the user performs a wiping operation to wipe dirt off the operation accepting surface 210 of the touch screen 21 by using a cloth 400 for cleaning. Here, in a wiping operation performed with button operations with respect to the software buttons SB displayed on the touch screen 21 effective, the wiping operation can be detected as the button operation. Accordingly, processing corresponding to the software buttons SB can be performed against the user's intension.

To prevent this, this embodiment prepares a panel cleaning mode in which operations with respect to the touch screen 21 are made ineffective. The panel controller 20 performs starting-condition judging processing of judging whether or not a starting condition, which has been determined in advance, has been fulfilled. In a case where the panel controller 20 has judged, as a result of the starting-condition judging processing, that the starting condition has been fulfilled, the panel controller 20 shifts to the panel cleaning mode, and starts an operation in the panel cleaning mode. Here, in a case where the starting condition is fulfilled when the power supply mode is the normal mode, the shift to the panel cleaning mode is made with the normal mode maintained as the power supply mode. In a case where the starting condition is fulfilled when the power supply mode is the power-saving mode, the shift to the panel cleaning mode is made with the power-saving mode maintained as the power supply mode.

In the panel cleaning mode, the panel controller 20 performs ending-condition judging processing of judging whether or not an ending condition which has been determined in advance has been fulfilled. In a case where the panel controller 20 has judged, as a result of the ending-condition judging processing, that the ending condition has been fulfilled, the panel controller 20 ends the panel cleaning mode (that is, the panel controller 20 finishes the operation in the panel cleaning mode).

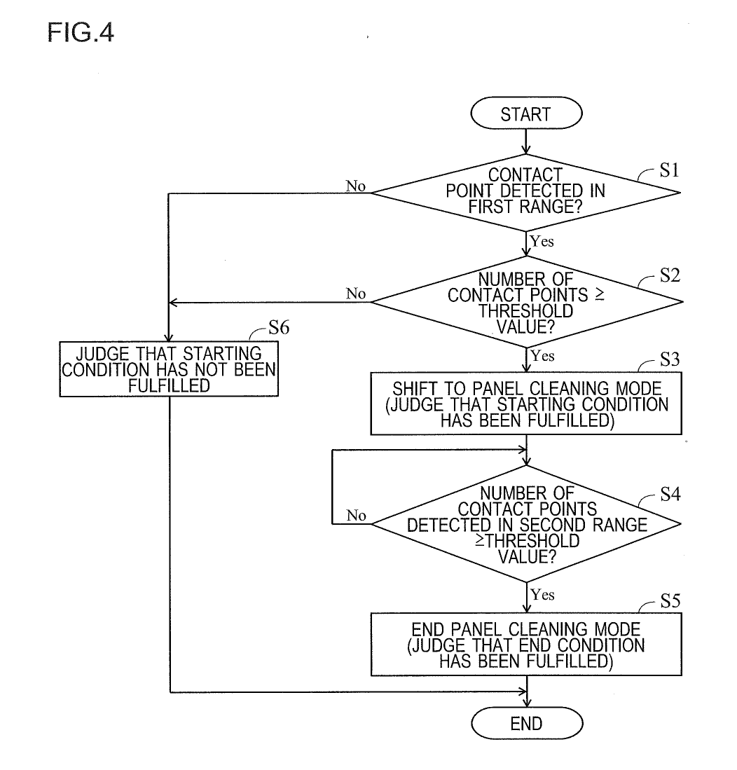

Hereinafter, with reference to the flowchart illustrated in FIG. 4, a description will be given of the starting-cdndition judging processing and the ending-condition judging processing performed by the panel controller 20. In the flowchart illustrated in FIG. 4, a flow starts when the panel controller 20 detects that a contacted body has been brought into contact with the operation accepting surface 210 of the touch screen 21. Here, at the starting time point in the flowchart illustrated in FIG. 4, the power supply mode may be whichever of the normal mode and the power-saving mode.

In step S1, the panel controller 20 judges whether or not a contact point has been detected in a first range R1 (see FIG. 5), which has been determined in advance in the operation accepting surface 210 of the touch screen 21. In a case where the panel controller 20 has judged, as a result, that a contact point has been detected in the first range R1, the flow proceeds to step S2.

Here, a description will be given of the first range R1. For example, as illustrated in FIG. 5, the operation accepting surface 210 of the touch screen 21 is divided into four regions 210R. In FIG. 5, the four regions 210R are divided from each other by broken lines. The four regions 210R each include a different corner C of the operation accepting surface 210. The first range R1 is set within one of the regions 210R. Although not particularly limited, the first range R1 is a range that includes part (part including a corner C) of the upper left one of the regions 210R. In FIG. 5, the first range R1 is enclosed by a thick line.

Back to FIG. 4, in step S2, the panel controller 20 judges whether or not the number of contact points simultaneously detected in the first range R1 is equal to or more than a threshold value, which has been determined in advance. In a case where, as a result, the panel controller 20 has judged that the number of the contact points simultaneously detected in the first range R1 is equal to or more than the threshold value, the flow proceeds to step S3. In step S3, the panel controller 20 judges that the starting condition has been fulfilled, and shifts to the panel cleaning mode. At this time, even when the power supply mode is the power-saving mode, the panel controller 20 does not perform processing of transmitting the return signal to the main body controller 10 (the processing of returning the power supply mode to the normal mode).

Here, a description will be given of the threshold value. As illustrated in FIG. 3, the cloth 400 for cleaning is used in a wiping operation performed by the user. In performing the wiping operation, the user uses his or her own hand to press the cloth 400 against the operation accepting surface 210 of the touch screen 21, and this results in a state in which a contacted body is in contact with the operation accepting surface 210 at a plurality of positions. As a result, in the case where the user performs the wiping operation, the panel controller 20 detects more contact points than at a time of accepting, from the user, a button operation (at which time, the panel controller 20 detecting only one contact point). Thus, the threshold value is set to a value that is larger than the number of contact points detected by the panel controller 20 at the time of accepting a button operation from the user.

Here, when the power supply mode is the power-saving mode, in a case where the panel controller 20 has detected that an operation of simultaneously touching two points on the touch screen 21 has been performed (in the operation, the number of contact points simultaneously detected by the panel controller 20 is two), the panel controller 20 judges that the returning condition has been fulfilled, and performs the processing of transmitting the return signal to the main body controller 10. That is, to this processing, an operation of simultaneously touching two points on the touch screen 21 corresponds. Accordingly, the threshold value is set to three.

If there is no other processing that corresponds to the operation of simultaneously touching two points on the touch screen 21, the threshold value may be set to two (the threshold value may be any value equal to or more than two). In a case where the threshold value is set to two, if the number of contact points simultaneously detected by the panel controller 20 is two or more, the panel controller 20 shifts to the panel cleaning mode. If, in addition to the operation of simultaneously touching two points on the touch screen 21, there is other processing that corresponds to an operation of simultaneously touching three points, the threshold value may be set to four (the threshold value may be any value equal to or more than four). In a case where the threshold value is set to four, if the number of contact points simultaneously detected by the panel controller 20 is four or more, the panel controller 20 shifts to the panel cleaning mode.

Back to FIG. 4, after the shift to the panel cleaning mode, in step S4, the panel controller 20 judges whether or not contact points of which the number is equal to or larger than a threshold value (which is a value equal to the threshold value used in the judgment on whether or not to shift to the panel cleaning mode) have been simultaneously detected in a second range R2 (see FIG. 5), which has been determined in advance in the operation accepting surface 210 of the touch screen 21. In other words, the panel controller 20 judges whether or not contact points of which the number is equal to or more than the threshold value and which have been simultaneously detected in the first range R1 have moved into the second range R2. In a case where the panel controller 20 has judged, as a result, that contact points of which the number is equal to or more than the threshold value have been simultaneously detected in the second range R2, the flow proceeds to step S5, but in a case where the panel controller 20 has judged that contact points of which the number is equal to or more than the threshold value have not been simultaneously detected in the second range R2, the processing in step S4 is repeated.

In step S5, the panel controller 20 judges that the ending condition has been fulfilled, and ends the panel cleaning mode. The panel controller 20 may instead end the panel cleaning mode at a time when a predetermined time has passed after the simultaneous detection of contact points of which the number is equal to or more than the threshold value in the second range R2.

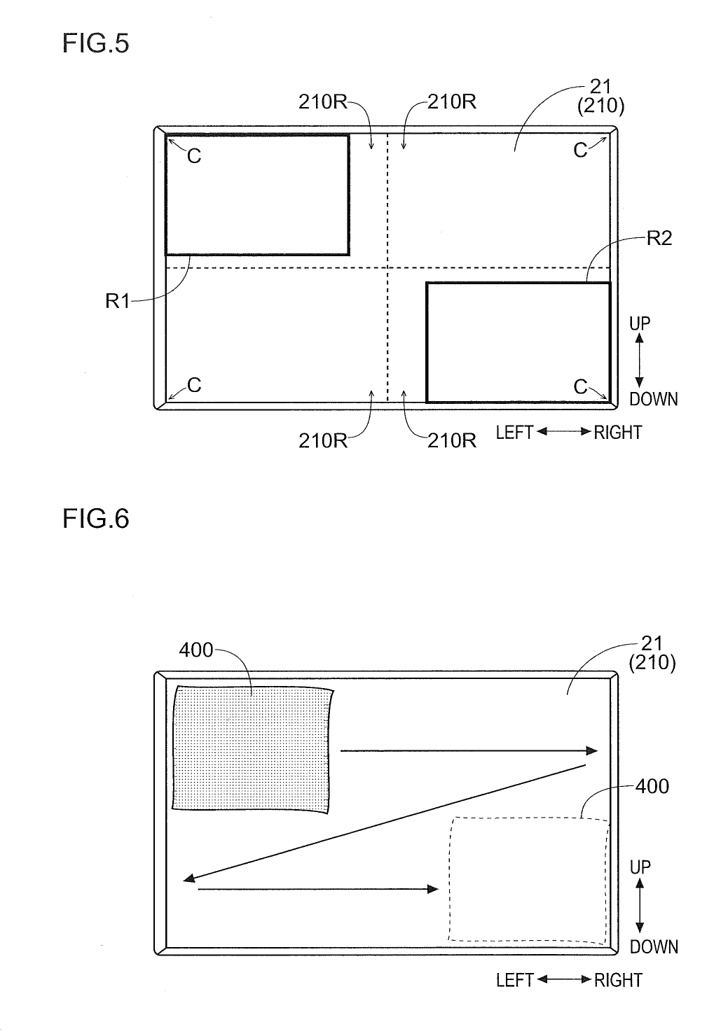

Here, with reference to FIG. 5 and FIG. 6, a description will be given of the second range R2. For example, as illustrated in FIG. 6, after starting the wiping operation in the first range R1, the user continues to reciprocate the cloth 400 for cleaning in a left-right direction or in an up-down direction to wipe dirt off the operation accepting surface 210 of the touch screen 21. In FIG. 6, the arrows indicate the track along which the cloth 400 is moved in a case where the user performs the wiping operation while reciprocating the cloth 400 in the left-right direction.

In the case where the user performs the wiping operation as illustrated in FIG. 6, the wiping operation is completed at a time point when the cloth 400 reaches a corner C that is positioned diagonal to the corner C of the first range R1. That is, the panel cleaning mode may be ended at this time point.

Thus, as illustrated in FIG. 5, the second range R2 is set within a lower right region 210R of the four regions 210R, the lower right region 210R being positioned diagonal to the region 210R that includes the first range R1. For example, the second range R2 is a range that includes part (part including a corner C) of the lower right region 210R. In FIG. 5, the second range R2 is enclosed by a thick line.

Here, two or more (or even all) regions 21OR of the four regions 21OR may each have the first range R1 set therein. For example, an upper left region 210R and the upper right region 210R may each have the first range R1 set therein.

In this case, the panel controller 20 performs range setting processing of automatically setting the second range R2 when the starting condition has been fulfilled (that is, on simultaneously detecting contact points of which the number is equal to or more than the threshold value in the first range R1. In the range setting processing, the panel controller 20 recognizes the first ranges R1 in which the contact points of which the number is equal to or more than the threshold value have been simultaneously detected, and sets the second range R2 in a region 210R that is positioned diagonal to a region 210R that includes the recognized first range R1. For example, in a case where the panel controller 20 has simultaneously detected contact points of which the number is equal to or more than the threshold value in the first range R1 inside the upper left region 210R, the second range R2 is set in the lower right region 210R, and in a case where the panel controller 20 has simultaneously detected contact points of which the number is equal to or more than the threshold value in the first range R1 inside the upper right region 210R, the second range R2 is set in the lower left region 210R.

Back to FIG. 4, in a case where, in step S2, the panel controller 20 has judged that the number of the contact points having been simultaneously detected in the first range R1 is less than the threshold value, the flow proceeds to step S6. The flow proceeds to step S6 also in a case where the panel controller 20 has judged, in step S1, that no contact point has been detected in the first range R1. In step S6, the panel controller 20 judges that the opening condition has not been fulfilled, and thus does not shifts to the panel cleaning mode. In step S6, the panel controller 20 changes the processing to perform, depending on whether the current power supply mode is the normal mode or the power-saving mode.

In a case where the power supply mode is currently the normal mode, the panel controller 20 judges whether or not a software button SB is displayed at a position overlapping with a detected contact point. If it is found, as a result, that a software button SB is displayed at a position overlapping with the detected contact point, the panel controller 20 performs the processing corresponding to the software button SB (that is, the panel controller 20 judges that a button operation has been performed with respect to the software button SB). On the other hand, if it is found that no software button SB is displayed at a position overlapping with the detected contact point, the panel controller 20 makes the touch screen 21 stay in the current state.

In a case where the power supply mode is currently the power-saving mode, the panel controller 20 judges that the returning condition has been fulfilled, and thus transmits the return signal to the main body controller 10. On receiving the return signal, the main body controller 10 returns to its normal state, and gives the power supply section 30 a return instruction, which is an instruction to return the power supply mode from the power-saving mode to the normal mode. Consequently, the power supply mode returns to the normal mode, and the image forming apparatus 1 becomes ready to operate.

Here, when the panel controller 20 shifts to the panel cleaning mode, the panel controller 20 makes the touch screen 21 display mode information related to the panel cleaning mode. The touch screen 21 displays, as the mode information, a message to the effect that a shift has been made to the panel cleaning mode. For example, a message “Currently in Panel Cleaning Mode” is displayed on the touch screen 21.

The touch screen 21 also displays how to end the panel cleaning mode (steps to end the panel cleaning mode). For example, the touch screen 21 displays a frame indicating the second range R2, and when the cloth 400 for cleaning enters the frame, the touch screen 21 displays a message to the effect that the panel cleaning mode is going to be ended. As will be described later, the operation panel 2 is provided with a mode switching button 22C (see FIG. 2), and it is also possible to end the panel cleaning mode by means of an operation with respect to the mode switching button 22C. Besides, the panel cleaning mode can be ended also by an operation with respect to the home button 22H. Thus, the touch screen 21 also displays, as the mode information, a message to the effect that the panel cleaning mode can be ended also by operating the mode switching button 22C or the home button 22H.

In a case where a shift has been made to the panel cleaning mode when the power supply mode is the normal mode, the supply of power to the display panel 211 is maintained even after the shift to the panel cleaning mode. That is, the touch screen 21 is allowed to perform display. Thus, in the case where a shift has been made to the panel cleaning mode when the power supply mode is the normal mode, the touch screen 21 never fails to display the mode information.

On the other hand, in a case where a shift has been made to the panel cleaning mode when the power supply mode is the power-saving mode, the supply of power to the display panel 211 needs to be restarted to allow the touch screen 21 to display the mode information. Restarting the supply of power to the display panel 211 despite the fact that the power supply mode is the power-saving mode would lower the power saving effect. To prevent this, in the case where a shift has been made to the panel cleaning mode when the power supply mode is the power-saving mode, the mode information does not need to be displayed on the touch screen 21.

However, without the mode information displayed on the touch screen 21, it is impossible for the user to know whether or not a shift has been made to the panel cleaning mode. To prevent this inconvenience to the user, even in the case where a shift has been made to the panel cleaning mode when the power supply mode is the power-saving mode, the mode information may be displayed on the touch screen 21. Alternatively, a setting on whether or not to allow display of the mode information may be accepted from the user in advance such that the mode information is displayed on the touch screen 21 only in a case where a setting has been made to the effect that the display of the mode information is allowed. Here, even when the mode information is displayed when the power supply mode is the power-saving mode, since the displayed mode information includes a message to the effect that a shift has been made to the panel cleaning mode, the mode information is not confusing to the user (thus, the user never mistakenly recognizes that a return has been made to the normal mode).

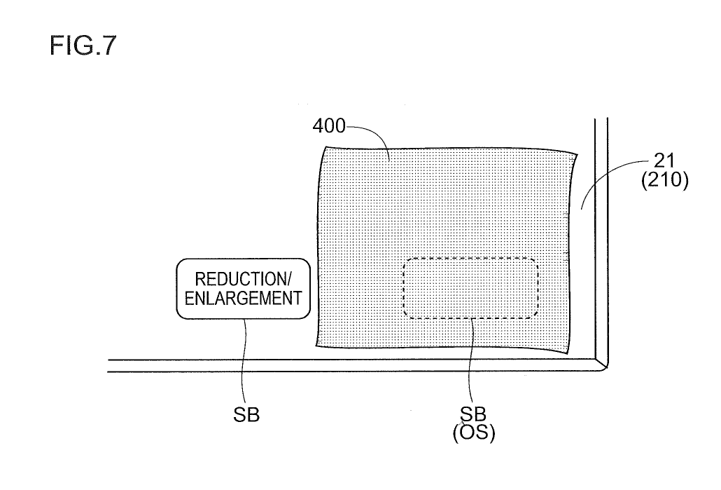

In a case where the ending condition has been judged fulfilled (that is, when the panel cleaning mode is to be ended), the panel controller 20 performs processing of recognizing, as a target button, a software button SB that is displayed at a position overlapping with any one of contact points of which the number is equal to or more than the threshold value and which have been simultaneously detected in the second range R2. For example, when the panel controller 20 has judged that the ending condition has been fulfilled, if any one of the software buttons SB is covered with the cloth 400 for cleaning as illustrated in FIG. 7, the panel controller 20 can recognize the software button SB that is covered with the cloth 400 as a target button. In FIG. 7, a sign OS is added to the software button SB that is covered with the cloth 400 (the software button SB that the panel controller 20 can recognize as the target button).

In a case where a software button SB has been recognized as a target button, the panel controller 20 keeps the processing corresponding to the software button SB that has been recognized as the target button ineffective until a predetermined time passes after the end of the panel cleaning mode. That is, the panel controller 20 does not perform the processing corresponding to the software button SB that has been recognized as the target button until the predetermined time passes after the end of the panel cleaning mode. The predetermined time is a few seconds (two to three seconds), for example. Then, when the time passing after the end of the panel cleaning mode reaches the predetermined time, the panel controller 20 cancels the ineffectiveness of the operation corresponding to the software button SB that has been recognized as the target button.

Here, in a case where the panel controller 20 has detected a pressing operation with respect to the mode switching button 22C, too, the panel controller 20 judges that the opening condition has been fulfilled, and thus shifts to the panel cleaning mode. Further, in a case where the panel controller 20 has detected a pressing operation (a long pressing operation) with respect to the home button 22H, too, the panel controller 20 judges that the opening condition has been fulfilled, and thus shifts to the panel cleaning mode. That is, the user can make the operation panel 2 shift to the panel cleaning mode also by performing an operation with respect a hardware button 22.

When operating in the panel cleaning mode, on detecting a pressing operation with respect to the mode switching button 22C, the panel controller 20 judges that the ending condition has been fulfilled, and thus ends the panel cleaning mode. Further, in the panel cleaning mode, on detecting a pressing operation (a long pressing operation) with respect to the home button 22H, the panel controller 20 judges that the ending condition has been fulfilled, and thus ends the panel cleaning mode. That is, the user can end the panel cleaning mode also by performing an operation with respect to a hardware button 22.

The operation panel 2 (the display/input device) of this embodiment includes, as has been described above, the touch screen 21 and the panel controller 20 (the controller). The panel controller 20 detects a contact point of a contacted body with respect to the touch screen 21. When the number of simultaneously detected contact points is equal to or more than the threshold value, which has been set to a value that is equal to or more than two, the panel controller 20 shifts to the panel cleaning mode, in which operations with respect to the touch screen are made ineffective.

According to the configuration of this embodiment, when the user presses the cloth 400 for cleaning against the touch screen 21 to perform a wiping operation, the panel controller 20 detects that a contacted body has been brought into contact with the touch screen 21. Here, for an efficient wiping operation, the user presses the cloth 400 in s spread state against the touch screen 21. Accordingly, when the user is going to perform a wiping operation, the number of contact points detected by the panel controller 20 increases, and thus the number of contact points detected by the panel controller 20 is likely to be equal to or more than the threshold value. If the number of detected contact points is equal to or more than the threshold value, the panel controller 20 automatically shifts to the panel cleaning mode. Consequently, when the user is going to perform a wiping operation, operations with respect to the touch screen 21 is made ineffective without the user performing any dedicated operation.

The threshold value is more preferably set to a value that is equal to or more than three. By thus setting the threshold value, it is possible to prevent inconvenience that, in a case where a pinch operation (a pinch-in operation, a pinch-out operation), which is a touch operation of touching two points on the touch screen 21 and then changing the distance between the two touched points, is set to correspond to other processing, when the user performs a pinch operation, a shift is made to the panel cleaning mode against the user's intention.

Further, in this embodiment, as described above, the panel controller 20 shifts to the panel cleaning mode in a case where the panel controller 20 has detected contact points of which the number is equal to or more than the threshold value in the first range R1. With this configuration, even when the user performs, by mistake, an operation in which the number of contact points is equal to or more than the threshold value, if the operation has been performed outside the first range R1, the operation panel 2 does not shift to the panel cleaning mode. This makes it possible to prevent the operation panel 2 from needlessly shifting to the panel cleaning mode.

Here, as a modified example, a configuration may be adopted where the panel controller 20 does not shift to the panel cleaning mode at the time point of detection of contact points of which the number is equal to or more than the threshold value. According to the configuration of this modified example, on simultaneously detecting contact points of which the number is equal to or more than the threshold value in the first range R1, the panel controller 20 does not shift to the panel cleaning mode, but judges whether or not the contact points having been detected in the first range R1 have moved. In a case where it is found, as a result, that the contact points of which the number is equal to or more than the threshold value and which have been simultaneously detected in the first range R1 have not moved and the contact of the contacted body with respect to the touch screen 21 has been released, the panel controller 20 makes the operation panel 2 stay in the current state (making no shift to the panel cleaning mode). On the other hand, in a case where it is found that the contact points of which the number is equal to or more than the threshold value and which have been simultaneously detected in the first range R1 have moved, the panel controller 20 shifts to the panel cleaning mode. Here, if the contact points of which the number is equal to or more than the threshold value and which have been simultaneously detected in the first range R1 have moved, it means that the user has started a wiping operation.

According to the configuration of the modified example, even when the user performs, by mistake, an operation in which the number of contact points in the first range R1 is equal to or more than the threshold value, if the operation is canceled immediately, the operation panel 2 does not shift to the panel cleaning mode. This helps prevent the operation panel 2 from needlessly shifting to the panel cleaning mode. That is, according to the configuration of the modified example, unless the user starts a wiping operation, no shift is made to the panel cleaning mode.

Now, in this embodiment, as described above, the first range R1 is set in one of the regions 21OR in the operation accepting surface 210 of the touch screen 21, and the second range R2 is set in another region 210R that is positioned diagonal to the region 210R including the first range R1 in the operation accepting surface 210. According to this configuration, the user starts a wiping operation from a corner C of the operation accepting surface 210, then wipes dirt off the touch screen 21 while moving the cloth 400 for cleaning in the up-down direction or in the left-right direction, and then when the user finally reaches another corner C that is positioned diagonal to the corner C at which the user has started the wiping operation (that is, when the cloth 400 moves into the second range R2), the panel cleaning mode is automatically ended. Consequently, the user does not have to perform an operation to end the panel cleaning mode, and this is convenient to the user. Furthermore, it is possible to prevent the operation panel 2 from being left in the panel cleaning mode.

In this embodiment, as described above, when the panel controller 20 ends the panel cleaning mode, the panel controller 20 performs the processing of recognizing, as a target button, a software button SB displayed at a position overlapping with a contact point having been detected in the second range R2, and in a case where the software button SB having been recognized as the target button exists, the panel controller 20 keeps operations with respect to the software button SB having been recognized as the target button ineffective until a predetermined time passes after the end of the panel cleaning mode. With this configuration, it is possible to prevent inconvenience that the operation panel 2 performs some processing against the user's intension though the panel cleaning mode has been ended.

In this embodiment, as described above, if the number of contact points detected when the power supply mode is the power-saving mode is not equal to or more than the threshold value, the panel controller 20 does not shift to the panel cleaning mode, but performs processing of returning the power supply mode to the normal mode (the processing of transmitting the return signal to the main body controller 10), and if the number of contact points detected when power supply mode is the power-saving mode is equal to or more than the threshold value, the panel controller 20 does not perform the processing of returning the power supply mode to the power-saving mode, but shifts to the panel cleaning mode. With this configuration, even when the user performs a wiping operation when the power supply mode is the power-saving mode, it is possible to prevent the power supply mode from needlessly returning to the normal mode.

In the configuration of this embodiment, when the operation panel 2 has shifted to the panel cleaning mode, for example, the touch screen 21 may display a screen of a color (such as gray) against which fingerprints and dust stand out. If a screen of such a color is displayed on the touch screen 21, it becomes easy to find out which part of the touch screen 21 should be cleaned with high priority (it becomes easy to find out a dirty point), and this is convenient to the user.

It should be understood that the embodiments disclosed herein are merely illustrative in all respects, and should not be interpreted restrictively. The range of the present disclosure is shown not by the above descriptions of embodiments but the scope of claims for patent, and it is intended that all modifications within the meaning and range equivalent to the scope of claims for patent are included.

What is claimed is:

1. A display/input device comprising:
a touch screen; and
a controller which
detects a contact point of a contacted body with respect to the touch screen, and,
when a number of the contact point detected simultaneously is equal to or more than a threshold value set to a value equal to or more than two, shifts to a panel cleaning mode in which an operation with respect to the touch screen is made ineffective.

2. The display/input device according to claim 1,
wherein
the controller shifts to the panel cleaning mode in a case where the controller has detected the contact point of which a number is equal to or more than the threshold value in a first range which has been determined in advance in the touch screen.

3. The display/input device according to claim 2,
wherein
the controller ends the panel cleaning mode in a case where the controller has detected the contact point of which the number is equal to or more than the threshold value in a second range which has been determined in advance in the touch screen.

4. The display/input device according to claim 3,
wherein
the touch screen has an operation accepting surface which is quadrangular in shape,
the operation accepting surface is divided into four regions each including a different corner of the operation accepting surface,
the first range is set in one region of the four regions of the operation accepting surface, and
the second range is set in such a region of the four regions of the operation accepting surface as is positioned diagonal to the one region which includes the first range in the operation accepting surface.

5. The display/input device according to claim 1,
wherein,
when the controller ends the panel cleaning mode, the controller performs processing of recognizing a software button displayed at a position overlapping with the contact point as a target button, and, in a case where the software button having been recognized as the target button exists, the controller keeps an operation performed with respect to the software button recognized as the target button ineffective until a predetermined time passes after the panel cleaning mode is ended.

6. The display/input device according to claim 1,
wherein
the controller does not shift to the panel cleaning mode at a time point when the contact point of which the number is equal to or more than the threshold value is detected, and the controller shifts to the panel cleaning mode at a time point when it is detected that the contact point of which the number is equal to or more than the threshold value has moved.

7. The display/input device according to claim 1, further comprising a power supply section which performs supply of power to the touch screen in a normal mode or in a power-saving mode in which less power is consumed than in the normal mode,
wherein
if the number of the contact point detected when the power supply mode is the power-saving mode is not equal to or more than the threshold value, the controller does not shift to the panel cleaning mode but performs processing of returning the power supply mode to the normal mode, and
if the number of the contact point detected when the power supply mode is the power-saving mode is equal to or more than the threshold value, the controller does not perform the processing of returning the power supply mode to the normal mode but shifts to the panel cleaning mode.

8. The display/input device according to claim 1,
wherein
when the controller has shifted to the panel cleaning mode, the controller makes the touch screen display a message to the effect that a shift has been made to the panel cleaning mode, and makes the touch screen display how to end the panel cleaning mode.

9. An image forming apparatus comprising the display/input device according to claim 1.
